(19) United States
(12) Patent Application Publication
(10) Pub. No.: US 2024/0083483 A1
(43) Pub. Date: Mar. 14, 2024

(54) PROTECTION SYSTEM FOR PROTECTING TRANSPORTED GOODS

(71) Applicant: Kupek GmbH, Schneckenlohe (DE)

(72) Inventor: Udo Kerbsties, Marktheidenfeld (DE)

(21) Appl. No.: 18/272,237

(22) PCT Filed: Jan. 12, 2022
(86) PCT No.: PCT/EP2022/050497

§ 371 Date: Jul. 13, 2023

(30) Foreign Application Priority Data
Jan. 15, 2021 (DE) 10 2021 100 734.8

(51) Int. Cl. B62B 5/00

(52) U.S. Cl. CPC B62B 5/0013

(57) ABSTRACT

A protection system is provided for protecting transported goods on a roll container, the protection system comprising at least one lateral wall, and the roll container comprising at least one lateral surface, the at least one lateral wall partially or fully covering the at least one lateral surface, and the protection system comprising at least one fastener. The at least one fastener is configured to connect the protection system to the roll container in a reversible or irreversible manner, and the protection system is made of a flexible material.

### FIELD OF THE INVENTION

The invention relates to a protection system for protecting transported goods according to the preamble of claim 1.

### BACKGROUND OF THE INVENTION

Several protection systems for protecting transported goods on roll containers are known from the prior art. The prevention of falling goods during transport plays a major role in this context. In addition, the protection system is supposed to protect the transported goods from weather conditions, other contaminations and theft.

The most common method is to wrap the roll container with adhesive film after loading. The film effectively prevents the transported goods from falling down by binding the transported goods to the laterally installed lattices of the roll container. It also prevents casual theft by passers-by, as the goods remain inaccessible for easy access. The disadvantage, however, is that the application of the adhesive film is time-consuming and must be carried out by a person or by machine. In addition, it is necessary to cut the film in order to remove the goods. This makes reuse impossible and produces a large amount of waste after each transport.

An alternative to the film is the installation of a protection system in the form of a lattice or a net. However, both forms of protection system have the disadvantage that they only protect sufficiently large transported goods from falling and theft. In addition, the use of a net or a lattice leaves the transported goods unprotected from weather conditions and other contaminants. Furthermore, the lattice and the net have the disadvantage of being heavy and bulky compared to the adhesive film. This makes return transport and storage of the protection systems together with the roll container difficult.

In addition, a protection system is known which is made of a plastic fabric or a strong film. The protection system essentially has the shape of the transport container and is pulled over the roll container for mounting, which usually requires two people. Mounting is very laborious or impossible in particular in the case of badly placed and/or bulky transported goods. Although this protection system offers shielding against weather conditions, it does not prevent the transported goods from falling down. Small transported goods, in particular, push the protection system aside when falling down and slip through the gap between the wall and the roll container.

Recently, the use of boards or plates made of reusable plastic has become more widespread. They are attached to the lattices of the roll containers by means of straps. While they are lighter than lattices, for example, they also take up a lot of space. As a result, they also make return transport and storage of the roll containers more difficult. Moreover, they offer only limited protection against weather conditions. They are also difficult to install on the roll container.

Therefore, there is a great need for a reusable, inexpensive, lightweight protection system for transported goods transported on a roll container which protects the transported goods from falling out, theft and/or weather conditions, is simple, easy and quick to install and allows access for authorized persons. In addition, the protection system should be inexpensive to manufacture, durable, and individually adaptable as required to the size, the quantity, and the preferred and appropriate outer packaging of the transported goods, with a further focus on being able to stow the protection system as compactly and space-savingly as possible. The invention has therefore set itself the object of providing a protection system to overcome the difficulties mentioned above.

This object is attained in a surprisingly simple but effective manner by a protection system according to the teaching of independent main claim 1.

### SUMMARY OF THE INVENTION

According to the invention, a protection system for protecting transported goods on a roll container is proposed, the protection system comprising at least one lateral wall, and the roll container comprising at least one lateral surface, the at least one lateral wall being configured to partially or completely cover the at least one lateral surface, and the protection system comprising at least one fastening means. The protection system is characterized in that the at least one fastening means is configured to reversibly or irreversibly connect the protection system to the roll container, and the protection system is made of a flexible material.

The basic idea is to make the protection system suitable for reuse, to allow space-saving storage and easy return transport when not in use and yet to optimally protect the transported goods from unauthorized access, falling out, theft and/or weather conditions.

According to the invention, the protection system for transported goods on a roll container having at least one, preferably two, three or four, partially closed lateral surfaces has at least one, preferably two, three or four, lateral walls. The term “roll container” refers to a means of transport for transported goods which typically has a wheel mounted at each corner of a rectangular base plate. However, other geometric shapes of the base plate are also conceivable. Transported goods are placed on the base plate. The geometric shape of the design of the base plate creates corresponding lateral surfaces, on which side lattices can be mounted. For example, a rectangular base plate has four lateral surfaces, of which side lattices are typically attached to one, two, three or all four lateral surfaces. The side lattices give the stacked transported goods the necessary stability and allow easy maneuvering of the roll container by hand. Preferably, two side lattices are mounted on opposite lateral surfaces. In the context of the invention, the design of the at least one lateral wall and/or lateral surface is of secondary importance, meaning they can have the same or different designs. The subject matter of the invention is the protection system individually or in the state mounted on the roll container.

Furthermore, it has been recognized according to the invention that the at least one lateral wall is capable of partially or fully covering the at least one lateral surface. The term “covering” refers to the suitability of an object to cover or form a covering for something. It has been found that only when the transported goods are covered is it possible to protect them from unauthorized access, falling out, theft, and/or weather conditions. The term “completely covering” refers to the suitability of an object to envelop another object without gaps. The term “partially covering” refers to the suitability of an object for enveloping a localized, contiguous portion of another object.

In the context of the invention, it has been recognized that the protection system comprises at least one fastening means and is reversibly or irreversibly connectable to a roll container via said at least one fastening means. A reversible or irreversible connectability of the protection system to the roll container allows the protection system to be mounted and removed in a simple and quick manner by a single person. The term “reversibly or irreversibly connectable” refers to the suitability of an object to form a reversible or irreversible connection with another object. The term “reversible connection” refers to a connection that can be severed by performing specified actions without destroying the roll container or the protection system. The term “irreversible connection” refers to a connection that can only be severed by complete or partial destruction of the roll container or the protection system. Such a reversible or irreversible connection is made possible by any fastening means known to the person skilled in the art.

Furthermore, it has been recognized as essential to the invention that the protection system is made of a flexible material. The term “flexible” refers to any material that can be bent, pulled, compressed and/or deformed without damage due to the action of a force or moment and in accordance with the required conditions. By using flexible materials, the protection system itself can be optimally adapted to the roll container and/or the transported goods. In principle, any transported goods are conceivable. Flexible materials offer the advantage that they can be lighter and thinner than rigid materials. It is also known to a person skilled in the art that flexible materials are insensitive to impacts and stresses, whereas rigid materials are irreversibly deformed and even break under excessive stress. Furthermore, when using a flexible material, it is possible to fold, bend, roll, crumple and/or gather the protection system into a compact pack size when not in use. This simplifies the return transport of the protection system and the storage when not in use. Furthermore, it has been found that the transported goods are also prevented from falling by a protection system made of a flexible material if it is under sufficient mechanical tension. The application of mechanical tension to the protection system is made possible by the connection of the protection system to the roll container according to the invention. It has been recognized as essential to the invention that by integrating the side lattice of the roll container into the protection system, the latter is given the necessary stability, making it possible to dispense with rigid materials and use flexible materials.

So using a reversible connection makes it possible to detach the protection system from the roll container non-destructively when not in use in order to subsequently bring it to a compact pack size due to the use of a flexible material and to store it together with or separately from the roll container until the next use; in the case of an irreversible connection, on the other hand, the protection system on the roll container is brought to a compact pack size owing to the flexible material and is stored together with the roll container when not in use. Likewise, the transported goods can be optimally protected by applying tension into the compliant material via the connection of the protection system to the roll container.

By means of the invention, it is possible to provide a protection system which can be mounted in a simple, fast and easy manner by one person alone and which protects the transported goods from unauthorized access, falling out, theft, and/or weather conditions. The protection system is robust in the mounted state, long-lasting, lightweight, adaptable to the roll container and/or the transported goods and foldable in a space-saving manner, meaning it takes up less space than reusable protection systems known from the prior art, thus allowing more transported goods to be loaded onto the roll container. In this manner, transport costs can be reduced to a considerable extent. Furthermore, the protection system can be easily reduced to a handy and small pack size for optimal storage when not in use.

Advantageous embodiments of the invention, which can be realized individually or in combination, are shown in the dependent claims.

In an embodiment of the invention, it is conceivable that the fastening means, preferably a flat and/or point fastening means, is a hook-and-loop fastener, a belt, a magnet, a form-fitting part, a buckle, a button, such as a snap fastener, a zipper, a friction-welded seam, an adhesive seam and/or a rivet. Preferably, the protection system comprises two, three, four, five, six, seven, eight, nine, ten, eleven, twelve, thirteen, fourteen, fifteen, sixteen, seventeen, eighteen, nineteen, twenty or more differently or identically configured fastening means. It is known to the skilled person that the tensile force that a flat fastening means, such as, but by no means exclusively, a hook-and-loop fastener or a magnet, can absorb without unintentional opening depends directly on the dimensions of the surface of the fastening means. In this respect, a largest possible surface area is advantageous. It is further known to the skilled person that a point fastening means, such as, but by no means exclusively, a button or a buckle, forms a form-fitting connection by suitable design and/or placement. Hence, unintentional opening of point fastening means is not possible when used properly.

The use of the fastening means is not limited to the reversible or irreversible connection of the protection system to the roll container; according to the invention, at least one fastening means enables the reversible or irreversible connection of the protection system to the roll container. Other conceivable applications of a fastening means are the reversible connection to one or more other identically or differently configured protection systems and/or to another area of the protection system in order to protect a larger portion of the transported goods and/or to bring about an improved protection of the transported goods. In particular, a higher tension and/or a higher tightness is to be achieved. A further conceivable application is the maintenance of a partially or completely folded, bent, rolled, crumpled and/or gathered state of the protection system and/or the reversible connection of the protection system to the roll container in the aforementioned state. This facilitates transport and/or storage of the protection system when not in use. Preferably, the other part and/or the other area of the protection system has a fastening-means counterpart that can be connected to the fastening means. An example of a fastening means with a fastening-means counterpart is a hook-and-loop fastener, which can be configured as a barbed strap or as a loop strap compatible therewith. In addition, it is also conceivable that a fastening means takes on one or more uses. It has been recognized in the context of the invention that the design of the fastening means is basically arbitrary, but some fastening means are particularly preferred. Preferred is a hook-and-loop fastener, since it can be mounted in an easy and known way, usually with one hand. At the same time, it is possible to assign multiple uses to a hook-and-loop fastener element, depending on whether the protection system is mounted on the roll container or is removed and collapsed for storage. A magnet is another preferred option, as it can be attached to the side lattices of the roll container. It has been recognized that the side lattices of the roll containers are typically made of a magnetic material, such as iron. With the help of a magnet, a fast adhesion of the protection system to the roll container is thus guaranteed by means of the magnetic attraction force between the magnet and the side lattice caused by the magnetic field. Another preferred option is a form-fitting part, in particular a form-fitting part that is pulled over the upper edge of the side lattice of the roll container in a form-fitting manner. Particularly preferred is a form-fitting part that is pulled over the upper edge of the side lattice. An even more preferred fastening means is a buckle, as it can also be connected to multiple different counterparts. A buckle is resistant to tensile force. Preferably, the buckle is a click buckle or an adjustable buckle. Another conceivable design is a zipper, as it enables a connection, in particular a connection resistant to weather conditions, over a wider distance. Particularly preferably, an irreversible fastening means is used to irreversibly connect the protection system to the roll container. This means that the protection system is available at all times. Further preferably, the fastening means is a friction-welded seam and/or an adhesive seam, as these can be resistant to weather conditions.

In a preferred embodiment, it is conceivable that the lateral wall comprises an outer side, an inner side, an upper edge, a lower edge and/or at least one lateral edge and the fastening means is disposed in the area of the outer side, the inner side, the upper edge, the lower edge and/or the at least one lateral edge. Furthermore, it is conceivable that the at least one fastening means is disposed laterally and/or centrally of the upper edge, the lower edge and/or the at least one lateral edge and in any conceivable region therebetween. Preferably, one, further preferably two, three, four, five, six, seven, eight, nine, ten or more, fastening means are located at regular or irregular intervals at the upper edge, the lower edge and/or at least one lateral edge. It is also conceivable that two, three, four, five, six, seven, eight, nine, ten or more differently and/or identically configured fastening means are located at the same location. In the context of the invention, it has been recognized that the placement of the fastening means has a great influence on the practicability, in particular with regard to the mounting and removal thereof. For example, if the fastening means is disposed on the inner side of the lateral wall, it can be easily connected to the lateral surface of the roll container. A fastening means on the outer side of the lateral wall is particularly useful with regard to the connection to one or more other identically or differently designed protection systems and/or to another part of the protection system with the above mentioned advantages. A fastening means at the upper edge of the protection system enables quick mounting of the protection system on the roll container. However, if the fastening means is located at the lower edge, the lateral wall can be put under tension in this manner with the result that the lateral wall of the protection system is in contact with the lateral surface of the roll container and prevents the transported goods from falling out. Fastening means at the side edges also enable tension to be applied, but also give the protection system increased tightness and/or enable the protection system to be closed. Fastening means attached centrally bring the lateral wall into closer contact with the lateral surface and thereby stabilize the transported goods in their intended position. Furthermore, they can additionally increase the tension of the lateral walls and thus prevent the transported goods from falling down.

It is further conceivable that the protection system comprises two, three or four lateral walls in order to thus enclose all lateral surfaces of the roll container and to optimally protect the transported goods from unauthorized access, falling out, theft and/or weather conditions.

In yet another embodiment, it is conceivable that the protection system comprises a roof. To protect the transported goods optimally against unauthorized access, falling out, theft and/or weather conditions, in particular against snowfall or rain, a covering of the upper side of the roll container is advantageous. The design of the roof is arbitrary, but an overlap is preferred. It is conceivable that the protection system comprises at least one fastening means which enables a reversible or irreversible connection of the roof to another part of the protection system. Suitable fastening means for a reversible or irreversible connection are known to a person skilled in the art.

Furthermore, it is conceivable that the protection system comprises at least one flap. The overlap of two or more sections caused by the flap and according to the invention makes it possible to increase the protection against weather conditions and/or to keep the protection system reliably and safely at the compact pack size when not in use. Preferably, at least one fastening means is disposed on the at least one flap, further preferably a flat fastening means, such as a hook-and-loop fastener. Moreover, it has been recognized that a suitably designed flap also makes it possible to protect bulky and/or poorly placed transported goods with the protection system since the circumference of the protection system can be enlarged, if necessary. The term “flap” refers to a section of the protective cover which is placed overlappingly over another section of the same, another and/or a different part of the protective cover.

It is further conceivable that the protection system is a single part or is composed of multiple parts. A one-part protection system offers the advantage that all parts are always present. A multi-piece protection system, on the other hand, can simplify mounting considerably. In addition, the protection system can be optimally adapted to the roll container and/or the transported goods.

In yet another embodiment, it is conceivable that at least one lateral wall can be partially or completely opened and closed. Preferably, two, three, more or all lateral walls can be partially or fully opened and closed. If one lateral wall can be partially or fully opened and closed, the removal and the placement of transported goods in the roll container are possible even after the protection system has been mounted on the roll container. Especially if the transported goods do not have the same destination or origin, this approach accelerates the loading and unloading of the transported goods. It is also conceivable that the lateral wall can be opened and closed at several points in a locally limited manner so that access is possible specifically at the point where the transported goods to be taken out are located or where the transported goods to be put in are to be placed. Preferably, the protection system comprises at least one fastening means, which is described in detail elsewhere and which enables opening and closing the lateral wall by means of a reversible connection.

Furthermore, it is conceivable that the protection system comprises an anti-theft device. Within the scope of the invention, it has been recognized that the present systems are also intended to protect the goods against theft. In principle, several types of anti-theft device are conceivable. For example, it is conceivable that the protection system is connected to the roll container by means of a lock or is secured against unauthorized opening. In addition, it is conceivable that an alarm-generating electrical anti-theft device is installed.

In another embodiment, it is conceivable that the protection system comprises a coding. The configuration of the coding is arbitrary; preferred is a coding by chip, number, barcode, QR code and/or designation. Particularly preferred is a coding by means of a GPS tracker. A GPS tracker enables the location of the protection system and the roll container connected to the protection system. Even more preferred is a coding by means of an RFID chip. RFID chips can be detected by an external electronic system. This is also possible in the case of a distance between the electronic system and the RFID chip. Hence, it is possible that the transported goods are placed on a roll container and a designation matching the transported goods is stored in connection with the RFID chip. Subsequently, the designation is electronically transmitted to the target system in connection with the coding stored on the RFID chip. When the roll container is delivered to the destination together with the transported goods and the protection system, the electronic system registers the RFID chip and automatically books the transported goods as present.

In yet another embodiment of the invention, it is conceivable that the protection system comprises at least one, preferably two, three, four, five, six or more, openings. Preferably, the opening is located in the central area of the lateral wall to facilitate loading and unloading of transported goods. Even more preferably, the opening is located in the lateral area of the lateral wall. In this manner, the side lattice of the roll container can be gripped for safe control of the roll container. Preferably, the opening can also be opened and closed by means of at least one fastening means. Moreover, it is conceivable that the opening is also secured with an anti-theft device. Furthermore, it is conceivable that a fastening means which makes the opening openable and closable by suitable placement is included in the protection system.

In yet another preferred further embodiment, the protection system is made of a lightweight, liquid-repellent, waterproof, wipeable, machine-washable, water-jet-resistant, tear-proof, abrasion-proof, cut-resistant, long-lasting, heat-resistant, cold-resistant, UV-resistant, flame-retardant, antibacterial, antiviral, antifungal, translucent, transparent and/or food-safe material. In the context of the invention, it has been recognized that a lightweight material means little additional weight. In the transport industry, in particular, additional weight always means additional costs, in particular if the transported goods are to be transported by truck, airplane or ship, where the fuel consumption increases with the transport weight. A lightweight material is also an advantage for stowage, as it does not place excessive strain on the worker stowing the protection system. If the material is liquid-repellent and/or waterproof, it offers optimum protection against weather conditions. Since other events can also cause contamination of the protection system, however, it is advantageous if the protection system can be cleaned. This is in particular the case if the material is machine-washable, water-j et-resistant and/or wipeable. Under these conditions, cleaning can be done by means of a rag, a washing machine and/or a steam jet device. The use of a tear-proof, abrasion-proof, cut-resistant and/or long-lasting material enables the protection system to be used for a long time. In the context of the invention, it has been recognized that transported goods may be exposed to extreme external conditions. In particular, storage under heat, which can develop for example in a truck at high outside temperatures, or cold, as for example in a refrigerated warehouse, are conceivable. It has also been recognized that roll containers are sometimes stored outdoors, where they are exposed to direct UV light. Therefore it is advantageous if the material is heat-resistant, cold-resistant and/or UV-resistant. To protect the transported goods and the persons handling the transported goods from fire, it is also desirable that the material is flame-retardant. Since it is conceivable that the transported goods are food and/or objects intended for contact with food, it is preferred that the material is antibacterial, antiviral and/or antifungal. It is well known that bacteria, viruses and/or fungi are promoted in their growth by food and food residues and at the same time can cause adverse health effects in humans. It has been recognized that for optimal protection of the food and the objects intended for contact with food, it is advantageous if the material of the protection system is also suitable for contact with food. This is made possible with food-safe materials. In addition, it is advantageous if the material is translucent and/or transparent because in this case it is visible from the outside which transported goods are on the roll container. The term “food-safe” refers to materials that comply with the relevant legal requirements for food contact materials.

In yet another embodiment, it is conceivable that the protection system is made of a single-layer or multi-layer fabric or a single-layer or multi-layer film. In the context of the invention, it has been recognized that a fabric or a film fulfills one, multiple or all of the desired properties mentioned above. Particularly preferably, the material is a polyethylene ribbon fabric. Polyethylene ribbon fabric is lightweight, foldable, bendable, waterproof, wipeable, water-jet-resistant, tear-proof, abrasion-proof, long-lasting, heat-resistant, cold-resistant and translucent. Alternatively, it is conceivable that the material is made from a renewable raw material, such as cotton, or a bio-based plastic and/or is biodegradable. Such materials enable a particularly environmentally friendly production and/or disposal.

In yet another embodiment, it is conceivable that the protection system is collapsible. In the context of the invention, it has been recognized that a collapsible protection system is easy to transport and to store. It is arbitrary whether the protection system is collapsible due to the material used or the construction. In particular, a material is collapsible if it is foldable and/or bendable. Suitable materials are known to the skilled person. Also known to the skilled person are design options for ensuring collapsibility. For example, hinges or the insertion of seams at which strips with elastic materials are inserted are conceivable in this context.

It is basically arbitrary what is transported with the roll container and protected by the protection system. It is conceivable that the transported goods are wares, boxes, cartons, parcels, baskets, bags, trays, plants, sacks, containers, food, consumer staples, industrial goods, intermediate products, consumer products, medicines, and/or suitcases. It is also conceivable that two, three, four, five, six, seven, eight, nine, ten or more similar or dissimilar transported goods are transported in a roll container and protected by the protection system.

It is understood that the definitions and embodiments of the above terms apply to all aspects described in this description and hereinafter, unless otherwise indicated.

### BRIEF DESCRIPTION OF THE DRAWING FIGURES

Further details, features and advantages of the invention will be apparent from the following description of preferred embodiments in conjunction with the dependent claims. The respective features may be realized alone or in combination with each other. The invention is not limited to the embodiments. The embodiments are shown schematically in the figures. Identical reference signs in the individual figures designate identical or functionally identical elements or elements corresponding to one another in terms of their function.

FIG. 1 is a top view of a part of a protection system according to the invention;

FIG. 2 is a sequence of images illustrating the mounting of an embodiment of a protection system according to the invention.

### DETAILED DESCRIPTION

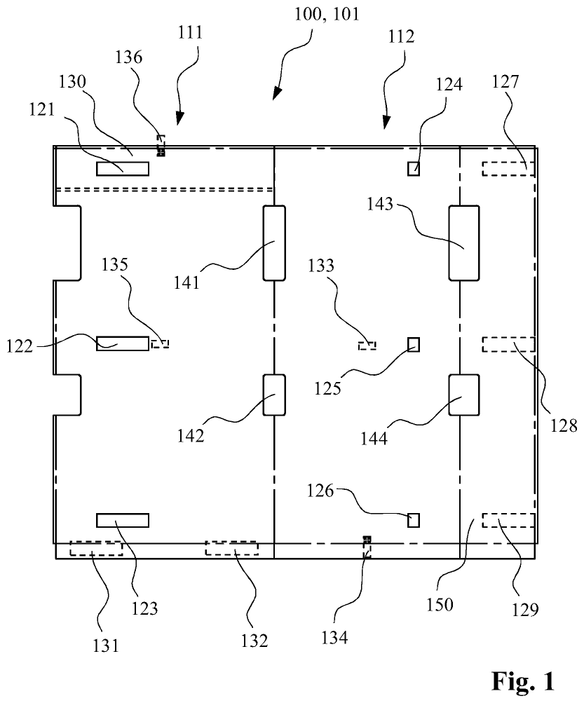

FIG. 1 shows a top view of a part of a protection system 100 according to the invention. In this embodiment, the protective cover 100 is composed of two parts. The first part 101 and the second part 102 are identical. It is also conceivable that the first and/or the second part 101, 102 are each suitable for covering one, two, three, four, five or more lateral surfaces of a roll container (not shown). Furthermore, it is conceivable that the individual parts of the multi-part protection system 100 are configured differently and can cover an equal or different number of lateral surfaces of the roll container (not shown).

As can be easily seen in FIG. 1, the first and the second part 101, 102 of the protection system 100 each have a first lateral wall 111 and a second lateral wall 112 in this embodiment. The first lateral wall 111 comprises a first fastening means 130, which can be pulled over a side lattice (not shown) of the roll container (not shown) in a form-fitting manner for mounting. The first fastening means 130 is located on the side of the first and the second part 101, 102 facing away from the drawing plane. This circumstance is indicated by the dashed line. The first fastening means 130 is formed by first disposing a flap at the upper edge of the first side 111 during production of the protection system 100; said flap is then folded back and connected laterally to the first part 111 by suitable means. Suitable connections are sewing, gluing or friction welding, for example. Other production methods of the first fastening means 130 are also conceivable in principle and are known to the skilled person. In addition, the first and the second part 101, 102 comprise a second and a third fastening means 131, 132, which are disposed at the lower edge of the first lateral wall 111 on the left side and on the right side, respectively. The second and the third fastening means 131, 132 are spaced apart from the lower edge and the lateral edge, as can be easily seen. It is also conceivable to place the second and third fastening means 131, 132 directly on the edge. In this embodiment, the second and the third fastening means 131, 132 are magnets. Furthermore, the first lateral wall 111 comprises a fourth, fifth and sixth fastening means 121, 122, 123, which are hook-and-loop fasteners in this embodiment. The fourth fastening means 121 is located at the upper edge on the left side, the fifth fastening means 122 is located centrally at the left edge, and the sixth fastening means 123 is located at the lower edge on the left side above the second fastening means 131. The fourth, fifth and sixth fastening means 121, 122, 123 are each spaced apart from the edges. However, it is also conceivable in principle that they are placed directly on the edges. In addition, it is also conceivable that the second and the sixth fastening means 131, 123 partially or completely overlap. This is due to their different mode of action and alignment. The second fastening means 131 is a magnet and can be connected to a side lattice (not shown). In use according to the invention, said side lattice is located on the side facing away from the viewing plane. The sixth fastening means 123, on the other hand, is disposed on the side facing the viewing plane, which generically also represents the direction of action of the sixth fastening means 123. The fourth, fifth and sixth fastening means 121, 122, 123 are rectangular in shape, the longer central perpendicular of the rectangular configuration being aligned parallel to the upper and lower edges of the first lateral wall 111. This alignment and the elongated design have the advantage that the circumference of the protection system 100 can thus be enlarged or reduced and can thus be optimally adapted to the transported goods. In principle, other configurations of the fourth, fifth and sixth fastening means 121, 122, 123 are also conceivable.

Furthermore, it can be readily seen from FIG. 1 that the protection system 100 further comprises a seventh, eighth and ninth fastening means 124, 125, 126. The seventh, eighth and ninth fastening means 124, 125, 126 are also hook-and-loop fasteners in this embodiment. The seventh fastening means 124 is disposed at the upper edge of the second lateral wall 124 on the right side. The eighth fastening means 125 is disposed centrally at the right edge of the second lateral wall 112. The ninth fastening means 126 is disposed at the lower edge of the second lateral wall 112 on the right side. The seventh, eighth and ninth fastening means 124, 125, 126 are spaced from the edges. However, it is also conceivable that they are placed directly on the edge. The function of the seventh, eighth and ninth fastening means 124, 125, 126 is to maintain a collapsed state. For this purpose, the second lateral wall 112 is folded onto the first lateral wall 111 and the seventh fastening means 124 is connected to the fourth fastening means 121, the eighth fastening means 125 is connected to the fifth fastening means 122 and the ninth fastening means 126 is connected to the sixth fastening means 123. Due to their function, it is possible for the seventh, eighth and ninth fastening means 124, 125, 126 to be significantly narrower than the third, fourth and fifth fastening means 121, 122, 123.

Furthermore, it can be seen from FIG. 1 that a first and a second opening 141, 142 are disposed at the edge between the first lateral wall 111 and the second lateral wall 112. The arrangement at the edge serves to enable gripping of a side lattice (not shown). In principle, however, it is conceivable to arrange one, two, three, four or more openings on the first lateral wall 111 and/or the second lateral wall 112 in addition to or instead of the first and second openings 141, 142. These openings can be used, for example, to remove transported goods from the roll container without having to remove the protection system 100. Between the second lateral wall 112 and a flap 150, the third and the fourth opening 143, 144 are disposed, which enable the gripping of a second side lattice (not shown) in the same way as the first and the second opening 141, 142.

At the right edge of the second lateral wall 112, the flap 150 is disposed across the entire length of the protection system 100, as also shown in FIG. 1. A tenth, an eleventh and a twelfth fastening means 127, 128, 129 are disposed on the flap 150. They are also hook-and-loop fasteners. The tenth fastening means 127 is disposed at the upper edge, the eleventh fastening means 128 is disposed centrally, and the twelfth fastening means 129 is disposed at the lower edge of the flap 150. To assemble the protection system, the tenth fastening means 127 of the first part 101 is connected to the fourth fastening means 121 of the second part 102. At the same time, the tenth fastening means 127 of the second part 102 is connected to the fourth fastening means 121 of the first part 101. In the same manner, the fifth fastening means 122 are connected to the eleventh fastening means 128 and the sixth fastening means 123 are connected to the twelfth fastening means 129 of the first and the second part 101, 102. In this manner, the first and second parts 101, 102 form a fully circumferential protection. Depending on where the tenth, eleventh and twelfth fastening means 127, 128, 129 are placed on the fourth, fifth and sixth fastening means 121, 122, 123, respectively, the circumference of the protection system 100 decreases or increases.

In the embodiment example according to FIG. 1, the protection system 100 additionally comprises a thirteenth, a fourteenth, a fifteenth and a sixteenth fastening means 133, 134, 125, 136. The thirteenth, fourteenth, fifteenth and sixteenth fastening means 133, 134, 135, 136 are also hook-and-loop fasteners. By means of the thirteenth, fourteenth, fifteenth and sixteenth fastening means 133, 134, 135, 136, the protection system 100 can be maintained in a folded state and the pack size can be significantly reduced when not in use. The placement of the fifteenth and sixteenth fastening means 135, 136 allows the protection system 100 to be collapsed and the collapsed protection system 100 to be fixed to the roll container (not shown), as the first fastening means 131 can still be connected to the roll container. In addition, the thirteenth, fourteenth, fifteenth and sixteenth fastening means 133, 134, 135, 136 may be included individually, in pairs or simultaneously in another embodiment. The collapsing and the fixation thereof by the thirteenth, fourteenth, fifteenth and sixteenth fastening means 133, 134, 135, 136 also enable convenient access into the protection system 100. The thirteenth fastening means 133 is centrally disposed at the lower edge of the second lateral wall 112. The fourteenth fastening means 134 is disposed centrally on the second lateral wall 112. The fifteenth fastening means 135 is disposed centrally on the first lateral wall 111, and the sixteenth fastening means 136 is disposed centrally at the upper edge of the first lateral wall 111. With respect to the positions of the fifteenth and sixteenth fastening means 135, 136, it is provided according to the invention that after the second lateral wall 112 has been folded onto the first lateral wall 111, the first and the second part 101, 102 of the protection system 100 are again folded twice along the central axis, which runs parallel to the upper and lower edges of the protection system 100, and are then fixed. In principle, however, other positions which support other folding, rolling and/or gathering techniques are also conceivable.

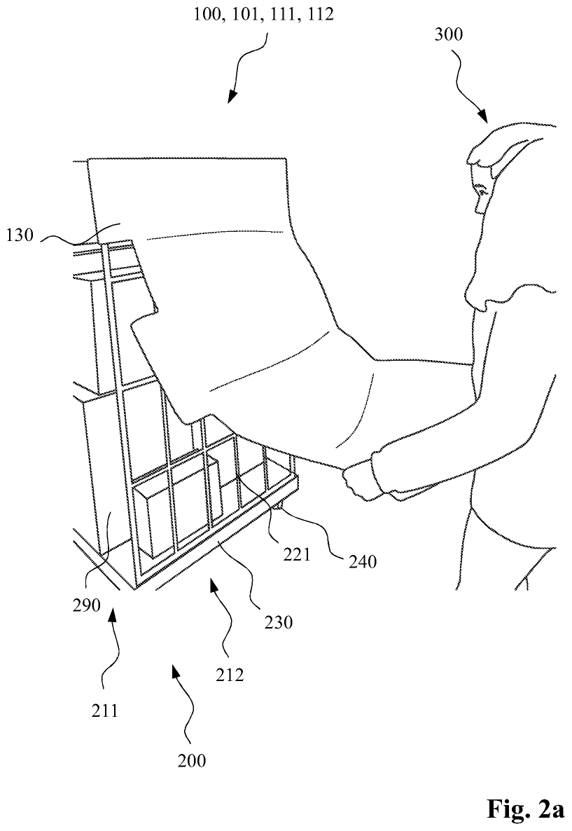

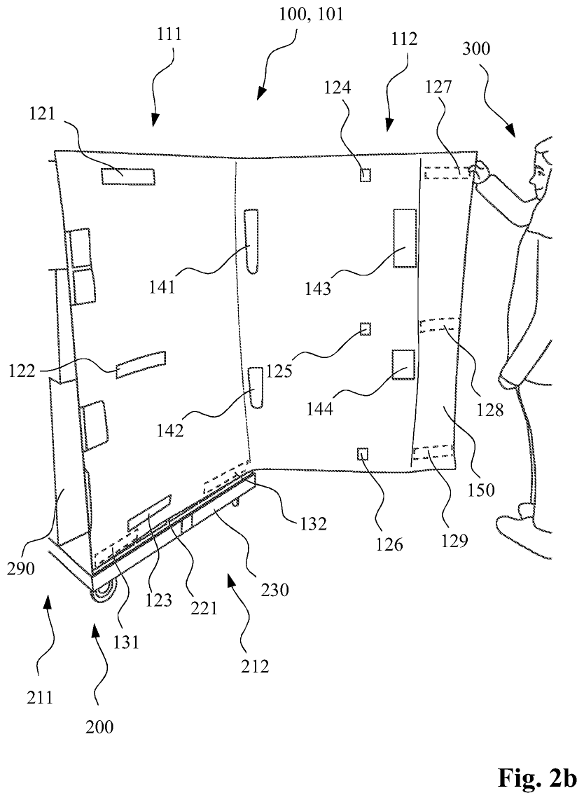

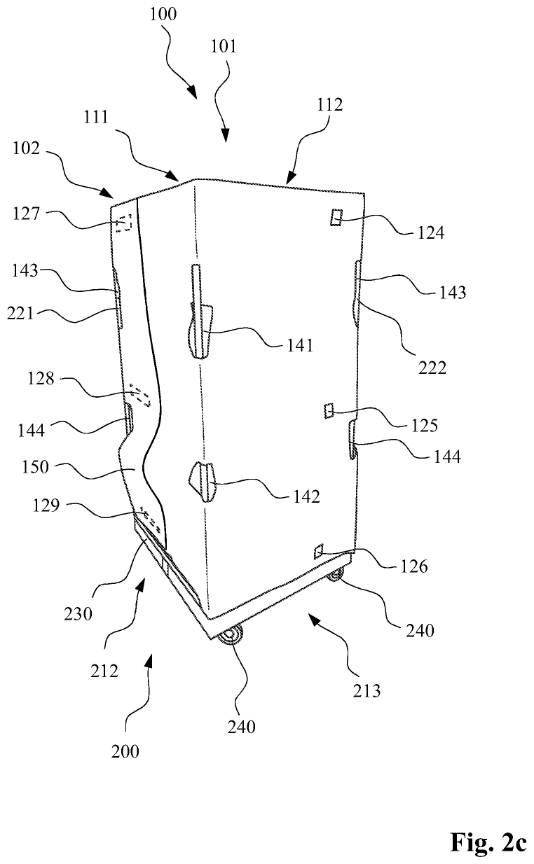

FIGS. 2a, 2b and 2c show the mounting of another embodiment of a protection system 100 according to the invention on a roll container 200. In this embodiment, the protection system 100 is composed of two parts, with both parts 101, 102 of the protection system 100 being identical. The two parts 101, 102 each cover two lateral surfaces 211, 212, 213. The sequence of figures in FIGS. 2a, 2b and 2c shows the mounting of the first part 101 of the protection system 100. The second part 102 of the protection system 100 is mounted on the roll container 200 in an identical manner on the other lateral surfaces 211, 212, 213 not covered by the first part 101. Due to the identical design of the first and second parts 101, 102, the second part 102 also has all the features of the first part 101 described below.

In FIG. 2a, the first part 101 of the protection system 100 has been reversibly connected to the roll container 200 by means of a first fastening means 130. In this embodiment, the first part 101 comprises a first and a second lateral wall 111, 112. The second lateral wall 112 is placed on the first lateral wall 111. An operator 300 holds the first part 101 in the lower region of the lateral edges of the first and second lateral walls 111, 112 in their hand. In this embodiment, the roll container 200 comprises four lateral surfaces 211, 212, 213 with the third and fourth lateral surfaces not shown. The first lateral surface 211 is open so that transported goods 290 can be placed on the roll container 200. The second lateral surface 212 is limited by a first side lattice 221. The first side lattice 221 not only prevents the transported goods 290 from falling down, provided that they are larger in their dimensions than the meshes of the first side lattice 221, but also enables the roll container 200 to be moved. In order for the roll container 200 to be movable in a simple manner, the roll container 200 comprises four wheels 240. The wheels 240 and the first side lattice 221 are mounted on a base plate 230, on which the transported goods 290 are also placed. The first fastening means 130 encloses the first side lattice 221 in a form-fitting manner at the upper edge. In this manner, the first part 101 remains connected to the roll container 200 even when the operator 300 lets go of the first part 101. It is therefore possible to mount the protection system 100 on the roll container 200 as a single person and with interruption of the operation.

FIG. 2b shows the next mounting step, in which the first part 101 is unfolded by the operator 300. The operator 300 has grasped the protection system at a flap 150 to fold the second lateral wall 112 off of the first lateral wall 111. The folding process is completed when the second lateral wall 112 has been rotated by a 270° angle about the axis connecting the first and second lateral walls 111, 112 and covers the third lateral surface (not shown) of the roll container 200. The first lateral wall 111 covers the second lateral surface 212 and the first side lattice 221 of the roll container 200. The protection system 100 is held in direct contact with the first side lattice 221 by a second and a third fastening means 131, 132, which are attached to the lower edge of the first lateral wall 111. In this embodiment, the second and third fastening means 131, 132 are magnets, which exert an attractive force on the metal first side lattice 221 with the aid of their magnetic field. They facilitate mounting of the protection system 100 and provide better protection against weather conditions. The second and third fastening means 131, 132 are disposed on the side of the first lateral wall 111 facing away from the viewing plane, as indicated by the dashed line. Also disposed on the first lateral wall 111 are a fourth, a fifth and a sixth fastening means 121, 122, 123, and a seventh, an eighth and a ninth fastening means 124, 125, 126 are disposed on the second lateral wall 112. In addition, the flap 150 comprises a tenth, an eleventh and a twelfth fastening means 127, 128, 129, which are disposed on the side of the flap 150 facing away from the viewing plane. This circumstance is indicated by the dashed line. The fourth, fifth, sixth, seventh, eighth, ninth, tenth, eleventh and twelfth fastening means 121, 122, 123, 124, 125, 126, 127, 128, 129 are hook-and-loop fasteners. The fourth, fifth and sixth fastening means 121, 122, 123 have a dual use in this embodiment. The first use is to facilitate collapsing of the protection system 100 on the roll container 200 by connecting the fourth, fifth and sixth fastening means 121, 122, 123 to the seventh, eighth and ninth fastening means 124, 125, 126. This condition is shown in FIG. 2a. Thus, the collapsed state is maintained, and the protection system 100 can be stowed more easily and in a space-saving manner. The second use of the fourth, fifth and sixth fastening means 121, 122, 123 is to be connected to the tenth, eleventh and twelfth fastening means 127, 128, 129 of the second part 102 (not shown) of the protection system 100. The tenth, eleventh and twelfth fastening means 127, 128, 129 of the first part 101 of the protection system 100 are connected in the same way to the fourth, fifth and sixth fastening means 121, 122, 123 of the second part 102 (not shown) of the protection system 100. The second lateral surface 212 also has four openings 141, 142, 143, 144. In the mounted state, the first side lattice 121 and a second side lattice (not shown), which is located on the fourth lateral surface (not shown) of the roll container 200, can still be grasped by hand, meaning the roll container 200 can be safely maneuvered.

FIG. 2c shows the roll container 200 rotated by 90° with respect to FIG. 2b, meaning the second lateral surface 212 and the third lateral surface 213 are visible. The first lateral wall 111 of the first part 101 covers the second lateral surface 212 with the first side lattice 221, while the second lateral wall 112 covers the third lateral surface 213. In addition, the flap 150 of the second part 102 can also be seen. The tenth, eleventh and twelfth fastening means 127, 128, 129 of the second part 102 are connected to the fourth, fifth and sixth fastening means 121, 122, 123 of the first part 101, which are not shown. In this way, the protection system 100 has been closed. It can be easily seen that the flap 150 of the second part 101 is overlapped over the first lateral wall 111 of the first part 102. It is also easily conceivable that, if bulky transported goods 290 protrude at least partially beyond the base plates 230, the overlap between the flap 150 of the second part 102 and the first lateral wall 111 of the first part 102 can be reduced. In this way, the circumference of the protection system 100 is increased, and the bulky transported goods 290 are also completely covered. The first side lattice 221 can be grasped through the first and the second opening 141, 142 of the first part 101 and through the third or the fourth opening 143, 144 of the second part 102. In addition, the third and fourth openings 143, 144 of the first part 101 allow grasping the second side lattice 222.

As can be easily seen in FIGS. 2a, 2b and 2c, the protection system 100 prevents unauthorized access, falling out and/or theft of the transported goods (not shown) and reliably protects them from weather conditions.

1. A protection system for protecting transported goods on a roll container, the protection system comprising at least one lateral wall, and the roll container comprising at least one lateral surface, the at least one lateral wall partially or fully covering the at least one lateral surface, and the protection system comprising at least one fastener, in which,
the protection system is reversibly or irreversibly connectable to the roll container via the at least one fastener, and the protection system is made of a flexible material.

2. The protection system according to claim 1, in which
the at least one fastener is a hook-and-loop fastener, a belt, a magnet, a form-fitting part, a buckle, a button, a zipper, a friction-welded seam, an adhesive seam, a rivet, and combinations thereof.

3. The protection system according to claim 1, in which
the at least one lateral wall comprises an outer side, an inner side, an upper edge, a lower edge and/or at least one lateral edge, and the at least one fastener is/are disposed in the area of the outer side, the inner side, the upper edge, the lower edge and/or the at least one lateral edge.

4. The protection system according to claim 1, in which
the protection system comprises two, three or four lateral walls.

5. The protection system according claim 1, in which
the protection system comprises a roof.

6. The protection system according to claim 1, in which
the protection system comprises at least one flap.

7. The protection system according to claim 1, in which
the protection system is a single part or is composed of multiple parts.

8. The protection system according to claim 1, in which
at least the at least one lateral wall is configured to be partially or fully opened and closed.

9. The protection system according to claim 1, in which
the protection system comprises an anti-theft device.

10. The protection system according to claim 1, in which
the protection system comprises a coding.

11. The protection system according to claim 1, in which
the protection system comprises at least one opening.

12. The protection system according to claim 1, in which
the protection system is made of a light-weight, foldable, bendable, flexible, liquid-repellent, waterproof, wipeable, machine-washable, water-jet-resistant, tear-proof, abrasion-proof, cut-resistant, long-lasting, heat-resistant, cold-resistant, UV-resistant, flame-retardant, antibacterial, antiviral, antifungal, food-safe, translucent, transparent material, or combinations thereof.

13. The protection system according to claim 1, in which
the protection system is made of a fabric or a film.

14. The protection system according to claim 1, in which
the protection system is collapsible.

15. The protection system according to claim 1, in which
the transported goods are wares, boxes, cartons, parcels, baskets, bags, trays, plants, sacks, containers, food, consumer staples, industrial goods, intermediate products, consumer products, medicines, suitcases, or combinations thereof.
